(19) United States
(12) Patent Application Publication
(10) Pub. No.: US 2020/0096959 A1
(43) Pub. Date: Mar. 26, 2020

(54) POWER SYSTEM SIMULATION BASED ON SNAPSHOT DATA

(71) Applicant: Schweitzer Engineering Laboratories, Inc., Pullman, WA (US)

(72) Inventors: Krishnanjan Gubba Ravikumar, Pullman, WA (US); Scott M. Manson, Moscow, ID (US); Mahipathi Reddy Appannagari, Pullman, WA (US); Benjamin E. Armstrong, Bend, OR (US)

(73) Assignee: Schweitzer Engineering Laboratories, Inc., Pullman, WA (US)

(21) Appl. No.: 16/136,883

(22) Filed: Sep. 20, 2018

(51) Int. Cl. G05B 17/02; G05F 1/66; G06F 17/50

(52) U.S. Cl. CPC G05B 17/02; G06F 2217/78; G06F 17/5036; G05F 1/66

(57) ABSTRACT

The present disclosure relates to systems and methods of simulating a power system using field data. For example, an embodiment may include a processor operatively coupled to a memory. The processor may receive a power system model representative of an actual power system. The processor may receive field data from the actual power system. The processor may initialize the power system model based on the field data to represent a state of the actual power system. The processor may simulate at least one scenario on the power system model. The processor may provide results of simulating the at least one scenario.

### TECHNICAL FIELD

The present disclosure relates generally to power system simulation and, more particularly, to a simulator that uses field data from a power system.

### BRIEF DESCRIPTION OF THE DRAWINGS

Non-limiting and non-exhaustive embodiments of the disclosure are described herein, including various embodiments of the disclosure with reference to the figures listed below.

FIG. 1 illustrates a simplified one-line diagram of an electric power transmission and distribution system with an accompanying monitoring system, in accordance with an embodiment.

FIG. 2 illustrates a network diagram of electronic devices communicating field data from the electric power transmission system of FIG. 1 to a simulator, in accordance with an embodiment.

FIG. 3 illustrates a flow chart of a process performed by the simulator of FIG. 2, in accordance with an embodiment.

FIG. 4 illustrates a block diagram of the simulator and an initialization gateway that communicates the field data to the simulator, in accordance with an embodiment.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Electric power delivery systems are used to distribute electric power from electric power generation sources to loads, which may be close or distant from the generation sources. Such systems may include generators or other sources, transformers step up or down voltages, transmission lines, buses, distribution lines, voltage regulators, capacitor banks, reactors, circuit breakers, switches, and other such equipment. Electric power delivery equipment may be monitored, automated and/or protected using intelligent electronic devices (IEDs).

To analyze and determine desired control actions on the electric power delivery system, operators may generate a power system model to represent the actual electric power delivery system in simulation tools. Such power system models may include the physical properties, layout, electrical connections, and equipment of the power system. For example, the power system model may include transmission line length, type, and voltage capabilities, generator type, size, and megawatt generation capabilities, transformer windings ratios, circuit breaker locations, and any other properties of the layout and/or design of the electric power delivery system.

The power system model may then be used in a simulator. For example, the simulator may be an electronic device on specific hardware, such as a field programmable gate array (FPGA), that is specifically designed to efficiently simulates scenarios using the power system model and allows engineers, planners, and other operators to assess results of the scenarios in the power system. From these results, operators may prescribe control actions, such as load shedding or generation shedding operations, to improve reliability of the power system. The simulator may initialize simulation of the power system model by setting simulator conditions that represent values in the power system to be preset values. For example, field parameters, such as voltages, currents, power, and circuit breaker status, among others, may be set to nominal values that are desired to be used in the simulation. Upon initialization, the simulator may receive inputs from the operator to simulate various contingencies that may occur in the power system. For instance, the simulator may receive inputs, via a human-to-machine (HMI) interface indicating a request to simulate a circuit breaker opening. The simulator may then simulate the request to determine a resulting state of the power system from the circuit breaker opening. The operator may then view the simulated result on a display of the HMI.

However, initializing the simulated power system to these nominal values may not accurately reflect the state of the actual power system in the real world. Because the nominal values, such as nominal voltages, nominal currents, nominal breaker status, and the like, may cause inaccuracies in the simulation, the results of the simulation may not accurately reflect the results that may occur in the actual power system if such scenarios were to occur. Accordingly, there is a need to more accurately represent the state of the actual power system in simulations.

Systems and methods to update the simulated power system based on field data are described below. In such systems, a first controller may be used to receive field data from various IEDs in a power system. The field data may include voltages, currents, breaker status, and other operating conditions of the power system at a snapshot in time. That is, the field data may represent a state of the power system at a particular moment in time. The first controller may then send the field data, as a file, to a first file server to store the conditions on the actual power system from that snapshot in time. The first file server may transfer the file to a second file server at an offsite repository. A second controller may receive the file from the second file server and read the file to send the field data to a simulator. The simulator may initialize a state of a power system model based on the received field data. That is, the state of the power system may be initialized to the state of the actual power system at the snapshot in time based on the measured operating conditions from the field.

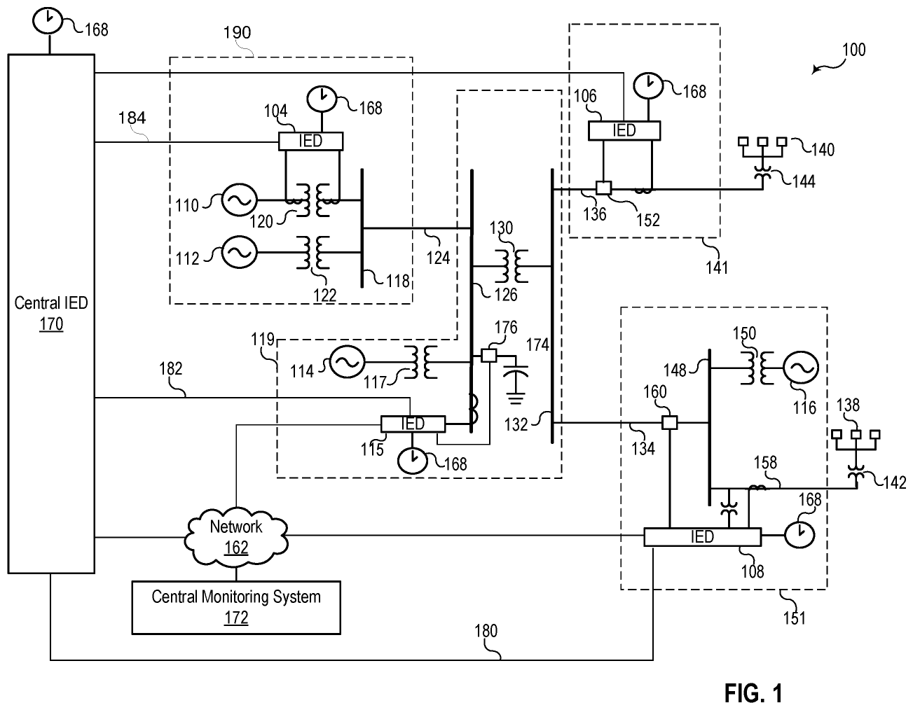

FIG. 1 illustrates a simplified one-line diagram of an alternating current electric power transmission and distribution system 100 consistent with embodiments of the present disclosure. Electric power delivery system 100 may be configured to generate, transmit, and distribute electric energy to loads. Electric power delivery systems may include equipment, such as electric generators (e.g., generators 110, 112, 114, and 116), power transformers (e.g., transformers 117, 120, 122, 130, 142, 144 and 150), power transmission and delivery lines (e.g., lines 124, 134, 136, and 158), circuit breakers (e.g., breakers 152, 160, 176), busses (e.g., busses 118, 126, 132, and 148), loads (e.g., loads 140, and 138) and the like. A variety of other types of equipment may also be included in electric power delivery system 100, such as voltage regulators, capacitor banks, and a variety of other types of equipment.

Substation 190 may include two generating sources 110, 112 feeding bus 118 via transformers 120, 122. Transformer 120 may be monitored and protected using IED 104.

Substation 119 may include a generator 114, which may be a distributed generator, and which may be connected to bus 126 through step-up transformer 117. Bus 126 may be connected to a distribution bus 132 via a step-down transformer 130. Various distribution lines 136 and 134 may be connected to distribution bus 132. Distribution line 136 may lead to substation 141 where the line is monitored and/or controlled using IED 106, which may selectively open and close breaker 152. Load 140 may be fed from distribution line 136. Further step-down transformer 144 in communication with distribution bus 132 via distribution line 136 may be used to step down a voltage for consumption by load 140.

Distribution line 134 may lead to substation 151, and deliver electric power to bus 148. Bus 148 may also receive electric power from distributed generator 116 via transformer 150. Distribution line 158 may deliver electric power from bus 148 to load 138, and may include further step-down transformer 142. Circuit breaker 160 may be used to selectively connect bus 148 to distribution line 134. IED 108 may be used to monitor and/or control circuit breaker 160 as well as distribution line 158.

Electric power delivery system 100 may be monitored, controlled, automated, and/or protected using intelligent electronic devices (IEDs), such as IEDs 104, 106, 108, 115, and 170, and a central monitoring system 172. In general, IEDs in an electric power generation and transmission system may be used for protection, control, automation, and/or monitoring of equipment in the system. For example, IEDs may be used to monitor equipment of many types, including electric transmission lines, electric distribution lines, current transformers, busses, switches, circuit breakers, reclosers, transformers, autotransformers, tap changers, voltage regulators, capacitor banks, generators, motors, pumps, compressors, valves, and a variety of other types of monitored equipment.

As used herein, an IED (such as IEDs 104, 106, 108, 115, and 170) may refer to any microprocessor-based device that monitors, controls, automates, and/or protects monitored equipment within system 100. Such devices may include, for example, remote terminal units, differential relays, distance relays, directional relays, feeder relays, overcurrent relays, voltage regulator controls, voltage relays, breaker failure relays, generator relays, motor relays, automation controllers, bay controllers, meters, recloser controls, communications processors, computing platforms, programmable logic controllers (PLCs), programmable automation controllers, input and output modules, digital sample publishing units, merging units, and the like. The term IED may be used to describe an individual IED or a system comprising multiple IEDs.

A common time signal may be distributed throughout system 100. Utilizing a common or universal time source may ensure that IEDs have a synchronized time signal that can be used to generate time synchronized data, such as synchrophasors and sampled values. In various embodiments, IEDs 104, 106, 108, 115, and 170 may receive a common time signal 168. The time signal may be distributed in system 100 using a communications network 162 or using a common time source, such as a Global Navigation Satellite System (“GNSS”), or the like.

According to various embodiments, central monitoring system 172 may comprise one or more of a variety of types of systems. For example, central monitoring system 172 may include a supervisory control and data acquisition (SCADA) system and/or a wide area control and situational awareness (WACSA) system. Central monitoring system 172 may be configured to provide protective operations for the system 100. A central IED 170 may be in communication with IEDs 104, 106, 108, and 115. IEDs 104, 106, 108 and 115 may be remote from the central IED 170, and may communicate over various media such as a direct communication from IED 106 or over a wide-area communications network 162. According to various embodiments, certain IEDs may be in direct communication with other IEDs (e.g., IED 104 is in direct communication with central IED 170) or may be in communication via a communication network 162 (e.g., IED 108 is in communication with central IED 170 via communication network 162).

In various embodiments, IEDs 104, 106, 108, 115, and 170 may be configured to monitor the frequency of alternating current waveforms in system 100. The measurements may be used in connection with the systems and methods disclosed herein for control of system 100. The IEDs may utilize common time source 168 to time-align measurements for comparison across system 100.

Network 162 may be used to transmit information among various components in system 100, including IEDs 108, 115, 170, and central monitoring system 172. In order to increase reliability, network 162 may include redundant communication paths between communicating devices. Such redundant paths may be selectively enabled when a first communication path is unavailable or disabled. Network 162 may include a variety of devices (e.g., multiplexers, routers, hubs, gateways, firewalls, switches, etc.) and technologies (e.g., connectionless communication network, SDN networks, etc.)

Measurements made by IEDs 104, 106, 108, and 115 may be communicated to central IED 170 and/or central monitoring system 172. In some embodiments, one or more of IEDs 108 and 115 may be configured to send a confirmatory signal through network 162 to central IED 170. In the illustrated embodiment, central IED 170 is in contact with IEDs 108 and 115 via analog communication channels 180 and 182, respectively. As described below, a simulator may use live field data from IEDs 104, 106, 108, and 115 to simulate operation of the electric power delivery system 100. By communicating live field data to the simulator, the simulator may more accurately model the state of the actual electric power delivery system 100.

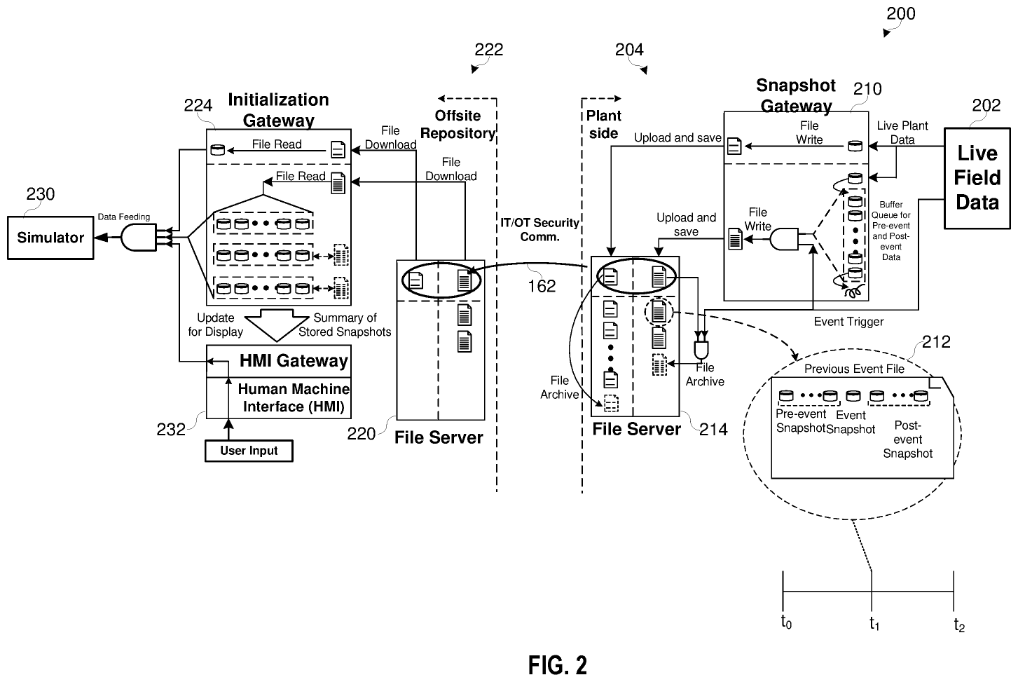

FIG. 2 is a network diagram of a simulation system 200 that uses live field data 202 from a plant side location 204 to initialize a power system model to represent the state of the actual power system in simulations. In the illustrated embodiment, plant side location 204 may refer to any location on the actual power system, such as a substation, a generation facility, or the like. The field data 202 may include voltage measurements, current measurements, frequency measurements, circuit breaker status, generator power generated, generator phase angle, or any other suitable live field data monitored by the IEDs 104, 106, 108, and 115 at that snapshot in time. The IEDs 104, 106, 108, and 115 may send the field data 202 to a first controller 210. The first controller 224, may be, for example, a real-time automation controller (RTAC), such as an SEL-3530 RTAC available from Schweitzer Engineering Laboratories, Inc., located in Pullman, Wash.

The first controller 210, which may also be referred to as a snapshot gateway, may receive the field data 202 from various IEDs in the actual power system. The first controller 210 may group the field data acquired by the IEDs at a particular time and generate a file of the field data from a snapshot in time to represent the state of the actual power system as measured at that instant in time. For example, the IEDs 104, 106, 108, and 115 may send the field data 202 with time stamps associated with the data. The first controller 210 may collect the field data 202 from the IEDs 104, 106, 108, and 115. The first controller 210 may group the field data 202 having the same or similar time stamps (e.g., within a period of time) together. In some embodiments, the first controller 210 may generate several files for field data to represent snapshots in time of the actual power system as time progresses and/or as events occur. In an embodiment, by grouping field data 202 from each of the IEDs 104, 106, 108, and 115 according to time stamps and using the data at the time stamps and preventing use of data from other times, the state of the power system may be assessed at the particular instant or instances in time consistently because the data reflects the same time or times on the power grid.

In the illustrated embodiment, the first controller 210 has a buffer in memory to allow for capturing field data 202 prior to the occurrence of an event. For example, if an overcurrent event were to occur at an IED causing a circuit breaker to open at time ti, the field data prior to the overcurrent event may be stored in the buffer and, upon occurrence of the event, the field data prior to (e.g., starting at to), during (e.g., ti), and following the event (e.g., until time t3) may be saved into memory as a file, thereby allowing operators to assess the event. The first controller 210 may maintain redundant files, which may be used in case communication or equipment is disconnected or not operating. The first controller 210 may then send the file to a first file server 214 to be stored.

The first file server 214 may be located at the plant side location 204 and store the files of various events that have occurred in the actual power system. In the illustrated embodiment, the first file server 214 may send a file to a second file server 220 at an offsite repository 222. For instance, the file server 214 may communicate the file via the network 162 or communicate the file directly to the second file server 220. The offsite repository 222 may be, for example, at the central monitoring station 172 or any other suitable location that may include a simulator 230.

The simulation system 200 may include a second controller 224 at the offsite repository 222. The second controller 224, may be, for example, another SEL-3530 RTAC available from Schweitzer Engineering Laboratories, Inc., located in Pullman, Wash. The second controller 224, also referred to as an initialization gateway, may receive the file of field data 202 from the second file server 220. The second controller 224 may read the field data 202 from the file and provide the field data 202 to a simulator 230, such as a real-time digital simulator. The real-time digital simulator may refer to a power system simulator that updates results of scenarios applied to a power system model on a human machine interface (HMI) 232 while an operator uses the HMI 232. Further, the simulator 230 may receive inputs via the HMI 232 to allow an operator to apply scenarios in simulating the actual power system. The simulator 230 may use the field data 202 from the second controller 224 to allow for more accurate simulation of the scenarios.

To secure communication of the field data from the plant 204 to the simulator 230, the first controller 230 may limit communication and data traffic delivered to the simulator 230. For example, the first controller 230 may secure communication by using a firewall, white-listing protection of the field data, a limited number of physical ports, among others.

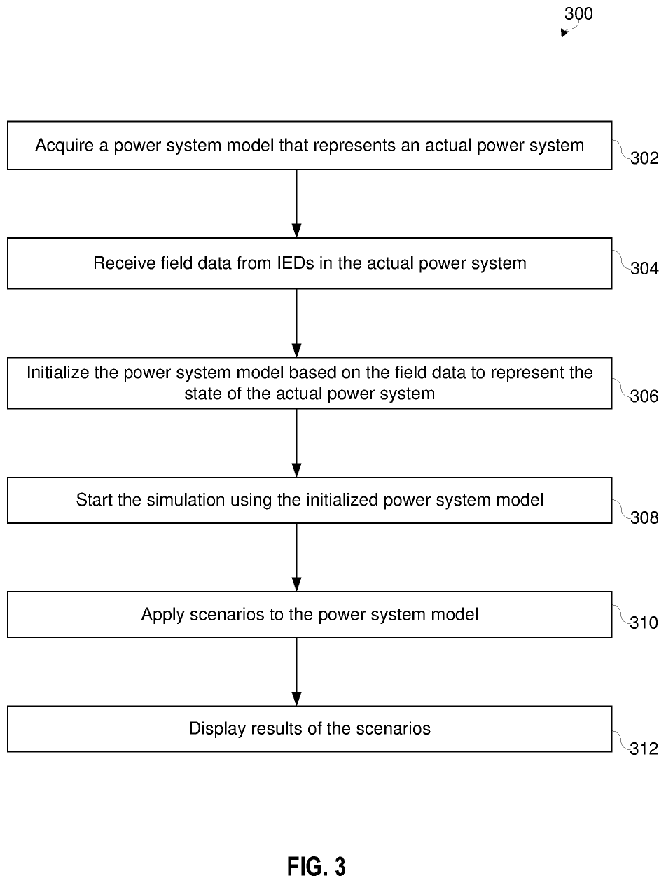

FIG. 3 is a process 300 that may be performed by the simulator 230 in conjunction with the second controller 224 and/or the HMI 230. The process 300 may be stored as instructions (e.g., code) and executed by one or more processor(s) of the simulator 230 to perform the actions described herein.

The process 300 may begin with the simulator 230 acquiring a power system model that represents an actual power system (block 302). For example, an operator may generate the power system model via the HMI 232 or another system. The simulator 230 may then receive the power system model from the second controller 224, the HMI 232, a file transfer (e.g., via universal serial bus (USB)), or any other suitable method. The power system model may be generated by operators to represent the equipment, power system components, layout, and other design aspects of the power grid.

The simulator 230 may receive field data collected by various IEDs in the actual power system (block 304). For example, the real-time simulator 230 may receive the field data via the process described with respect to FIG. 2. In such a process, the first controller 210 may generate a file of field data 202 and provide, via file servers 214 and 220 using network 162, the file to the second controller 224. The second controller 224 may then read the field data from the file and provide the field data to the simulator 230.

In some embodiments, the HMI 232 may receive an input from a user to acquire the field data to be used in the power system model. For example, the simulator 230 may receive an input, via the HMI 232, to acquire the most recently collected field data at a particular time. The simulator 230 may send a request to the second controller 224 to feed the most recently collected field data. In certain embodiments, the second controller 224 may send a request to the first controller 210 for the most recently collected field data. The first controller 230 may respond by grouping the most recent field data into a file and sending the file as described above. As explained above, a list of snapshots in time may be provided via the HMI 232. Upon selection of a snapshot, the second controller may send the data to the simulator for initialization.

The simulator 230 may then initialize the power system model based on the field data to represent the state of the actual power system at the time in which the field data 202 was collected (block 306). That is, the simulator 230 may initialize at least some setpoints of the power system model to be set to values of the measured voltages, measured currents, and the like, of the field data 202. For example, the simulator 230 may begin by setting setpoints of the power system model to nominal values initially received by the simulator 230. Then, the simulator 230 may execute instructions (e.g., scripts) to cause the simulator 230 to update the setpoints within the simulator 230 to the values from the field data 202 (e.g., prior to beginning the simulation). The instructions may be executed upon input from the HMI 232 or may be automatically executed during initialization.

In some embodiments, the field data 202, such as measured voltages, measured currents, and the like, may be time-stamped by the IEDs 104, 106, 108, and 115 and grouped together based on the time stamps. The initialized settings of the power system model may be from a particular time or period of time in the actual power system. For example, the simulator 230 may be initialized with data from timestamps at a certain time or within a certain period of time while excluding earlier and/or later time stamps from being used in the simulation. In certain embodiments, a combination of nominal values and field data may be used if some setpoints are not being monitored in the actual power system and are not derived. Further, in certain embodiments, some settings may be calculated and/or estimated based on the measured voltages, measured currents that are known in the system.

The simulator 230 may start the simulation of the actual power system using the power system model initialized with the field data 202 (block 308). By initializing the power system model based on field data, the power system model may more accurately represent the actual power system 100. During the simulation, the simulator 230 may receive inputs via the HMI 232 that allow the user to apply various scenarios to the power system model. In some embodiments, the scenarios available may be based at least in part on the initialization of the model. For example, the simulator 230 may prevent scenarios involving opening of a circuit breaker when the circuit breaker is already open on the actual power system.

The simulator 230 may receive a selection of one or more scenarios to occur in the power system model. For instance, the operator may select a scenario in which load is shed, generation is shed, a circuit breaker is opened, or overcurrent conditions occur, among others. The simulator 230 may then apply the one or more scenarios to the power system model (block 310).

The simulator 230 may provide the results of the one or more scenarios to the HMI 232 to be displayed on a display screen of the HMI 232 (block 312) to allow an operator to assess/visualize what would be expected to occur if the scenario were to occur in the actual power system. For example, the simulator 230 may display various operating conditions from the scenario applied to the power system model, such as voltages, currents, circuit breaker status, generator status, and any other suitable conditions. By initializing settings in the simulator 230 based on field data from the actual power system, the simulator 230 may provide more accurate results of what is expected to occur in such scenarios.

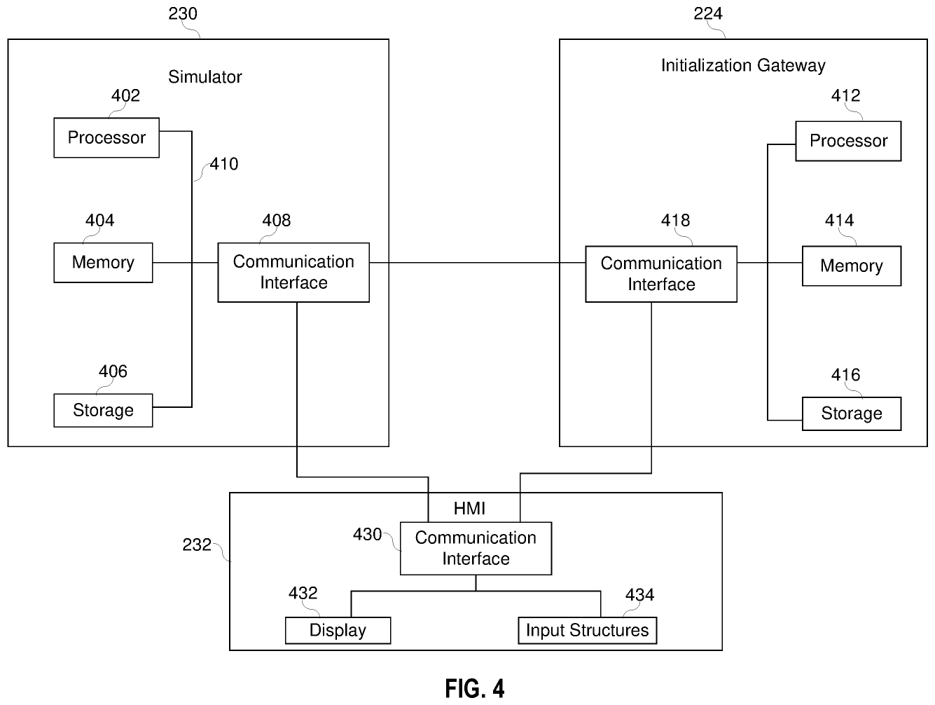

FIG. 4 is a block diagram of the simulator 230 in communication with the second controller 224, in accordance with an embodiment. The simulator 230 may include one or more processor(s) 402, memory 404, one or more computer-readable storage mediums 406, and/or a communication interface 408 communicatively coupled to one or more communication buses 410.

The processor 402 may be communicatively coupled with the memory 404 and/or the nonvolatile storage 406 to perform various operations. Such operations or instructions executed by the processor 402 may be stored in one or more tangible, computer-readable media at least collectively storing the instructions or routines, such as the memory 404 and/or the nonvolatile storage 406. The memory 404 and the nonvolatile storage 406 may include any suitable articles of manufacture for storing data and executable instructions, such as random-access memory, read-only memory, rewritable flash memory, hard drives, or any other suitable optical, magnetic, or solid-state storage medium, or a combination thereof. The memory 404 and/or the nonvolatile storage 406 may be a repository of one or more executable instructions (e.g., code) to implement any of the operations described herein.

The processor 402 may be embodied as hardware components, such as one or more general-purpose microprocessors, one or more special-purpose microprocessors, a general purpose integrated circuit, an application specific integrated circuit (ASIC), a field programmable gate array (FPGA), and/or other programmable logic devices. For example, the real-time simulator 230 may be implemented on an FPGA that is configured to perform operations to simulate transient power systems in real-time. Processor 402 and other related items in FIG. 4 may be generally referred to herein as processing circuitry. Furthermore, the processing circuitry may be a single contained processing module or may be incorporated wholly or partially within any of the other elements within the simulator 230.

In some embodiments, the communication interface 408 (e.g., communication circuitry and/or other inputs/outputs) may include a transceiver or connections to receive and/or transmit signal(s) to enable the processor 402 to communicate with other electronic devices, such as the second controller 234. For instance, the processor 402 may receive field data from the second controller 234 via the communication interface 408 to allow the processor 402 to perform the operations described herein. Further, the processor 402 may send one or more signal(s) to the HMI 232 to cause a display screen of the HMI 232 to display various aspects of the simulation. For example, the processor 402 may send signal(s) to cause the display screen to display the results of various scenarios simulated. Further, the HMI 232 may receive inputs from users to indicate various settings of the simulation. The processor 402 may receive the various settings via the communication interface 408.

The second controller 224 may include hardware (e.g., processor, memory, nonvolatile storage, etc.) similar to those described with respect to the real-time simulator 230. For example, the processor 412, the memory 414, the computer-readable medium 416, the communication interface 418, and the one or more communication buses 420 may be similar to the descriptions of the processor 402, memory 404, computer readable-medium 406, the communications interface 408, and the one or more communication buses 410, respectively, to allow the second controller 224 to perform the processes described herein with respect to the second controller 224. Further, the hardware of the first controller 210 may be the same or similar to the hardware of the second controller 224 to allow the first controller to perform the operations described with respect to the first controller 210, such as the communication with the IEDs. As mentioned above, the first controller 210, the second controller 224, and the simulator 230, may be communicatively coupled via the network 162 (e.g., through file servers 214 and 220) or other networks to communicate the field data and/or requests between the electronic devices.

The HMI 232 may include a communication interface 430 that communicatively couples the HMI 232 to the simulator 230 and the second controller 224. The second controller 224 may send one or more signal(s) indicating a summary of stored snapshots to the HMI 232 via the communication interfaces 430 and 418 to allow the HMI 232 to display the field data, organized by snapshots in time, on a display screen 432. For example, the HMI 232 may display a list of events by time the events occurred, the type of event, or the like. In some embodiments, the HMI 232 may display a control that allows recent (e.g., live) field data to be used.

The HMI 232 may include input structures 434 (e.g., buttons, keyboard, touchscreen, etc.) to enable the HMI 232 to receive inputs from the user. For example, the HMI 232 may receive a selection, from the list of field data, of field data to be loaded from the second controller 224 onto the simulator 230. Upon receiving the selection, the HMI 232 may send a signal to the second controller 224 to cause the second controller 224 to feed the field data of the selection into the simulator. In this manner, operators may perform scenarios on the power system model using any field data stored to allow for more accurate assessment of the power system.

Upon initializing the power system model using the selected field data, the input structures 434 may then receive inputs indicating various scenarios to apply to the power system model. Upon applying the scenarios, the HMI 232 may then display the results on the display screen 432 to allow operators to assess the conditions expected on the actual power system if the scenarios were to occur.

Systems and methods described herein may allow a simulator to simulate operation of an actual power system using live field data as measured from the actual power system. By using live field data, the simulator may more accurately simulate the conditions of the actual power system to allow operators to more accurately assess results of various scenarios that may occur on the actual power system. Further, a controller may collect field data and generate a snapshot of conditions on the actual power system from the field data. An HMI may allow users to select the field data from a list and to provide the results of scenarios to a user.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. A simulation system, comprising:
a processor operatively coupled to a memory, wherein the processor is configured to:
receive a power system model representative of an actual power system;
receive field data from the actual power system at a snapshot in time;
initialize the power system model based on the field data to represent a state of the actual power system at the snapshot in time;
simulate at least one scenario on the power system model; and
provide results of simulating the at least one scenario.

2. The simulation system of claim 1, wherein the processor is configured to receive live field data currently present on the actual power system to represent the current state of the actual power system in the power system model.

3. The simulation system of claim 1, comprising a human-to-machine interface (HMI) configured to display, on a display screen of the HMI, a plurality of stored snapshots of field data and to receive an input of a selected snapshot from the plurality of stored snapshots, wherein the processor is configured to initialize the power system model based on the field data in the selected snapshot.

4. The simulation system of claim 1, wherein the processor is configured to send one or more signals to a display screen of a human-to-machine interface (HMI) to display the results of the at least one scenario.

5. The simulation system of claim 1, wherein the power system model comprises a layout of the actual power system.

6. The simulation system of claim 1, wherein the processor is configured to initialize the power system model by setting setpoints of the power system model to nominal values and to update at least some of the setpoints to corresponding field data.

7. The simulation system of claim 1, wherein the field data comprises measured voltages, measured currents, circuit breaker status, or any combination thereof, from the actual power system.

8. The simulation system of claim 1, wherein the snapshot comprises a collection of field data, from a plurality of intelligent electronic devices, having time stamps within a period of time of an event on the actual power system to simulate the event on the actual power system.

9. The simulation system of claim 1, comprising:
a first controller configured to receive field data from one or more intelligent electronic devices (IEDs) of the actual power system and to generate a file of field data at a snapshot in time; and
a second controller configured to receive the file and to send the field data to the processor to allow the processor to initialize the power system model.

10. A simulation system, comprising:
a first controller configured to receive field data from one or more intelligent electronic devices (IEDs) of an actual power system and to generate a file comprising field data at a snapshot in time;
a second controller, at an offsite location, wherein the second controller is configured to receive the file and to send the field data to a simulator at the offsite location to initialize the simulator; and
the simulator comprising at least one processor and memory, wherein the processor is configured to:
receive a power system model representative of the actual power system;
receive the field data from the second controller;
initialize the power system model based on the field data to cause the power system model to represent a state of the actual power system at the snapshot in time;
simulate at least one scenario on the power system model; and
provide results of the at least one scenario.

11. The simulation system of claim 10, comprising a human-to-machine interface (HMI) configured to display a plurality of stored snapshots of field data and to receive an input selecting the snapshot in time from the plurality of stored snapshots, wherein the processor is configured to initialize the power system model based on the field data in the selected snapshot.

12. The simulation system of claim 11, wherein the HMI is configured to receive an input indicating a selection of the at least one scenario.

13. The simulation system of claim 10, wherein the first controller is configured to group the field data according to time stamps associated with measurements from the one or more IEDs to generate the file for field data at the snapshot in time.

14. The simulation system of claim 10, wherein the first controller is configured to group the field data into a file comprising pre-event data, event data, and post-event data.

15. The simulation system of claim 10, wherein the processor is configured to update the power system model based on the current state of the actual power system upon receiving an input from a user.

16. The simulation system of claim 10, wherein the simulator comprises a real-time digital simulator.

17. A method, comprising:
receive, at a simulator, a power system model representative of an actual power system;
receive, at the simulator, field data from one or more intelligent electronic devices (IEDs) in the actual power system;
initialize, at the simulator, the power system model based on the field data to cause the power system model to represent a state of the actual power system at a snapshot in time;
simulate at least one scenario on the power system model; and
provide, via the simulator, results of the at least one scenario.

18. The method of claim 17, wherein grouping the field data comprises generating a file of the field data to represent a snapshot in time.

19. The method of claim 17, comprising:
receiving, at a first controller, the field data from the one or more IEDs;
group, at the first controller, the field data from a snapshot in time into a file; and
sending the file to a first file server.

20. The method of claim 17, comprising:
sending the field data from the first file server to a second file server to allow the second file server to send the file to a second controller, wherein the second controller is configured to send the field data to the simulator.
